(19) United States
(12) Patent Application Publication
(10) Pub. No.: US 2003/0028765 A1
(43) Pub. Date: Feb. 6, 2003

(54) Protecting information on a computer readable medium

(76) Inventors: Daryl Carvis Cromer, Apex, NC (US); Brandon Jon Ellison, Raleigh, NC (US); Howard Jeffrey Locker, Cary, NC (US); Randall Scott Springfield, Chapel Hill, NC (US); James Peter Ward, Raleigh, NC (US)

Correspondence Address: IBM Corporation, Personal Systems Group Legal Dept., Dept. 9CCA/Bldg. 002-2, P.O. Box 12195, Research Triangle Park, NC, 27709, US

(21) Appl. No.: 09/919,240

(22) Filed: Jul. 31, 2001

(51) Int. Cl. H04L 9/00

(52) U.S. Cl. 713/164

(57) ABSTRACT

Data stored on a computer readable medium in a computing system is protected from being read within another computing system by encrypting a data structure, such as the FAT table of a disk recorded using a FAT-based file system or a portion of the master file table of a disk recorded using an NTFS file system. This data structure is used to find the files on the medium. Encryption and decryption preferably occur within a cryptographic processor of the computing system, with this data structure in a hard drive being encrypted as the computing system is shut down and decrypted after power on. In an alternate embodiment, a utility program provides for selective encryption and decryption of a data structure in a removable computer readable medium.

### BACKGROUND ART

The most important asset in a computing system is typically the data stored in the hard drive. A number of methods are being used to protect the physical assets of a computing system, including locks and cables tying computer equipment to furniture, locks preventing the opening of computer covers, and methods for identifying physical assets. In addition, a number of measures are taken to prevent unauthorized electronic access to data within computing systems, including the use of power-on passwords, and, for Microsoft WINDOWS NT users, logins. However, cover locks are often not used or may prove to be ineffective, allowing the hard file to be physically removed from a computing system.

In order to keep track of every file stored on a disk within a computer, whether a floppy disk or a hard file, the operating system of the computer places a boot record including a special program and a data table at the beginning of the information stored on the disk. Together, these elements of the boot record are used to provide information regarding the size and other properties of the disk. Next, the operating system places a FAT (File Allocation Table) on the disk to provide a structure by which the operating system of a computer keeps track of the data and instructions stored on the disk. On most disks, the operating system also creates a backup FAT, which is to be used if the first FAT becomes damaged.

There are presently three types of FAT tables that can be used in a hard drive, depending on the number of bits used to describe each cluster that can be accessed. Naturally, the number of clusters that can be accessed in a single hard file increases with an increase in the number of bits used in each entry. In the first PCs, DOS used twelve-bit numbers for each cluster entry. This type of 12-bit FAT is still used for floppy diskettes and for hard drives having a volume of less than 16 MB. Next, beginning with version 3 of DOS, a 16-bit FAT was used, particularly for hard drives having a capacity to store between 16 MB and 2 GB of data. Finally, with the OSR2 release of Microsoft WINDOWS 95, and continuing with WINDOWS 98, WINDOWS ME, and WINDOWS 2000, a 32-bit FAT generally used in a hard drive having a capacity greater that 2 GB.

FIG. 1 is a pictographic view of the 12-bit or 16-bit FAT formatting of the beginning portion of a hard drive disk, and FIG. 2 is a pictographic view of the 32-bit FAT formatting of such a disk. In the disk in FIG. 1, the boot record 10, which is written by DOS or WINDOWS, is stored in the first sector of the disk. In the disk of FIG. 2, the boot record 12 is typically stored in the first three sectors of the disk. The boot record 10, 12 includes a data table called the BIOS parameter block (BPB), which records information such as the number of bytes per sector, the total number of sectors on the disk, the number of copies of the FAT, the type of FAT, the number of sectors in the FAT, and the number of sectors in the root directory. In the disk of FIG. 2, a second copy 14 of the boot record is stored after a first reserved section 16 and before a second reserved section 18. In the disk of FIG. 1, a first copy 20 and a second copy 22 of the FAT are stored following the boot record. In the disk of FIG. 2, a first copy 24 and a second copy 26 of the FAT are stored following the second reserved section 18. The disk of FIG. 1 also includes a root directory 28 within the portion of the disk reserved for such system files. Within the data area 30 following the root directory 28 of the disk of FIG. 1, and similarly within the data area 32 following the second FAT table 26, address numbers are assigned sequentially to clusters, with the first sector in this area 30, 32 being given a number of 2.

Each of the FAT tables is a large table of numbers, with the number contained in each location in the table normally being an address of a cluster in which a next portion of a file is stored, so that linkage is established to let DOS or WINDOWS find all of the pieces of a file stored within various clusters on the disk. If the number 0 is stored in a table entry, the corresponding cluster is presently unused and available. If an end of file value is stored in the entry, the cluster stores the last portion of a file. Another predetermined value can be stored in an entry to indicate that the cluster is bad, so that it cannot be used.

The operating system also creates a table called the root directory. In the disk of FIG. 1, the root directory 28 is stored as shown at a fixed location within a system area of the disk. In the disk of FIG. 2, the root directory (not shown) is stored as a subdirectory within the data area 32. The root directory points to the beginning of various files stored on the disk.

FIG. 3 is a pictographic view of the formatting of a hard file according to the NT file system (NTFS), which is available for use with the Microsoft operating systems known as WINDOWS NT and WINDOWS 2000. This kind of file system stores data describing each directory in file data records 33 within a master file table 34, which is two, four, or eight sectors long. The first sixteen records of the master file table 34 are reserved for metadata files 36, reserved for use by the operating system. The attributes of the master file table 34 itself are stored in the first file 38 within the metadata files 36. Data is stored in a data area 39.

Since these file systems of FIGS. 1-3 are widely used for computer systems using DOS and WINDOWS, in the absence of an encoding system designed for the purpose, a computer system cannot be prevented from performing various operations on data recorded on a disk removed from another system, whether the disk is actually a removable disk or a disk within a hard drive removed from the other system and installed on the system to gain access to the data. Such operations include reading and copying any file or directory, as long as it is DOS-structured, and as long as it physically exists on the disk.

A conventional method for protecting data stored on computer disks involves the encryption of the data itself before it is written to the disk and subsequent decryption of the data when it is read from the disk. An example of this method is the Encrypting File System (EFS) used with the WINDOWS NTFS file system to encrypt sensitive data. Files that are encrypted with this method can be accessed only by using the private key of the private key/public key pair of a authorized user account associated with the computing system. The operation of EFS is transparent to applications running on the computing systems, since file data is automatically encrypted when an application running in the user account authorized to view the view the data changes the data, and such data is subsequently automatically decrypted when an authorized application reads the data. One problem with the various methods for encrypting data arises from the substantial amount of processing required in the encrypting and decrypting processes. Such processing typically requires the use of the system CPU and slows the reading of data from the disk and the recording of data on the disk. What is needed is a method protecting a large amount of data by encrypting a relatively small data structure.

Other conventional methods for protecting data stored on computer disks generally deal with providing copy protection of the magnetic storage medium, or with indirect methods, such as modifying file attributes so that files are hidden from directory searches, such as controlling the operating system boot, by controlling the access to files. An example of this kind of method is found in U.S. Pat. No. 5,327,563, issued to Singh in 1994, which describes a method for locking software programs to a particular disk. The method includes the steps of creating several files, one with a fixed name and at least one other file having a random name. Saving the head, cylinder, and sector information for each of the files in the corresponding file along with use count information, saving the names of all the files in the first tile with the fixed name, and encrypting all the files, this program locking method permits the distribution of trial copies of software programs and permits the distribution of trial copies of software programs and limits the risk that the program will be copied or used more than the permitted number of times. With such methods, the target file or directory and, in fact, the disk itself remains unsecured at a media level. A barrier to access generally can be bypassed, and the target file can be copied, even in an altered or encrypted form.

U.S. Pat. No. 5,557,674, issued to Yeow in 1996, describes a method by which an absolute static lock may be applied at a media level, to files and directories in File Allocation Table (FAT)-based storage media, of single machine personal microcomputers running within the Disk Operating System (DOS) or equivalent environment. To apply an absolute static lock at a media level on a target file or directory, the directory entry data field on disk for the target file or directory in the host machine is located and read into a convenient area of the host machine memory. The directory entry data field is restructured according to the procedure and in the non-DOS format of the invention. The original directory entry data field on the target media is replaced with the restructured non-DOS directory entry data field of this invention. The corresponding target file cluster information contained in the FAT is protected. Encryption of the target file contents may be incorporated into the absolute lock process if required. Target files or directories, upon which the absolute static lock of this invention has been successfully applied, cannot be accessed by DOS at media level, for the critical operations of read, copy, overwrite, and erase. The reverse unlock process, by which the previously applied absolute static lock may be removed from a target file or directory, restoring it to the original unlocked DOS state, is also disclosed. In the special case where the target media is a floppy, the method of applying, or removing, absolute static lock is also disclosed.

The method of U.S. Pat. No. 5,557,674 requires the user to interact with the program at several points. In the process of locking the file, the user is required to specify the pathname of the target file or directory to be locked, an access password for the locking process, and whether an option to encrypt the file contents is selected. What is needed is a method providing for the security of the data on a disk in an automatic manner, without requiring operator actions. Furthermore, the method of this patent causes file locking to be accomplished by restructuring the directory entry data field in a certain specified way. What is needed is a way of applying a powerful encryption algorithm to the to the FAT and/or to the directory entry data field.

Other methods for data protection deal with encryption of the stored data itself. For example, U.S. Pat. No. 4,780,905, issued to Cruts et al. in 1988, discloses a data encryption system for use in a computer system having at least one disk drive. A first memory is used for storing an encryption key and a second memory is used for storing data. Data from the second memory is logically combined with selected portions of the encryption key by a gate. Control hardware and software controls the reading and writing of data onto the disk, routing the data through the gate so that the data is automatically encrypted as it is written on the disk and decoded as it is read from the disk. Furthermore, an encryption key portion selection circuit controls the first memory so that it outputs a sequence of selected portions of the encryption key corresponding to the disk location where the data is stored or is to be stored.

The encryption of data on removable disks only is described in U.S. Pat. Nos. 5,007,082 and 4,780,905, issued to Cummins in 1991 and 1990, respectively, which disclose a method for providing data security using an encryption/ decryption algorithm which attaches at the primitive BIOS level of the operating system automatically during the power-on self-test routines. The encryption/ decryption process is implemented by intercepting the removable media or floppy diskette interrupt in order to add additional interrupt handling routing instructions which perform the encryption and decryption of data passed between the diskette controller and the data transfer buffer area within system RAM. Bitwise alteration of the data in a predefined relationship is used to encrypt and decrypt. The encryption/decryption system attaches before the computer power-up sequence and renders data entry hardware active. Hence, the user cannot readily override the security system. Data stored on nonremovable media, such as hard disk media, is not encrypted, thereby preserving the integrity of more permanent data. This method thus does not address the problem of removing a computer hard drive to obtain access to stored data.

Private key/public key cryptography is made possible by the development of asymmetric cryptography, in which the key used to encrypt a message is different from the key used to decrypt the message. Before the development of asymmetric cryptography, cryptographic methods were symmetric, with a process carried out with a key to encrypt a message being reversed with the same key to decrypt the encrypted message. The tremendous advantage of public key cryptography arises from the fact that there is no need to develop a method for distributing private keys to all of the people who may need them. With public key cryptography, each computing system communicating encrypted messages has both a private key and a public key. The public key is used to encrypt messages and the private key is used to decrypt messages. The public key is made widely available, while the private key is held as a secret within the computing system. When a sender wants to send an encrypted message to a receiver, he encrypts it with the public key of the receiver. When the receiver receives the message, he decrypts it with his private key. Since no one else knows his private key, no one else can decrypt the message, even if they intercept the public key and the message during transmission. The private key cannot reasonably be deduced or calculated from the public key. This type of cryptography was proposed by Whiffield Diffie and Martin E. Hellman, and is described in U.S. Pat. No. 4,200,770, issued to Hellman et al. in 1980, the disclosure of which is incorporated herein by reference. Another asymmetric key algorithm, named the RSA algorithm after the inventors Ronald L. Rivest, Adi Shamir, and Leonard M. Aldeman, is described in U.S. Pat. No. 4,405,829, issued to Rivest et al. in 1983, the disclosure of which is incorporated herein by reference.

Within a computing system, cryptographic processes manipulate the binary numbers representing an alphanumeric message according to a key. The manipulation includes, for example, substitution and transposition, in which elements of the message are substituted for other elements, or their positions are switched, or both. What is needed is a method for applying cryptographic processes, including private key/public key cryptography, to prevent the reading of data in a hard file removed from a computing system, without incorporating a requirement that the data must be encrypted before it is recorded and decrypted after it is read.

Conventionally, cryptographic processes occur within the general-purpose computer hardware in accordance with a cryptographic routine executing within the microprocessor of the computer. However, it is known that various means have been used surreptitiously to obtain control of a computing system in a manner allowing a remote user to gather secret information stored within the system. A routine for gaining control of a computer in this way is typically a part of a “Trojan horse” program, which is disguised as a game, utility, or other application to be downloaded or otherwise installed by an unknowing user. Alternately, such a routine may be part of a “back door” program surreptitiously installed by an intruder on a computer left unattended or left behind by a disgruntled employee to gain future access to the computing system. What is needed is a method for applying cryptographic processes to secure data recorded on a disk without the cryptographic processes themselves, and the private keys they use, being exposed to the surreptitious operation of such intrusive programs within the computing system.

### SUMMARY OF THE INVENTION

Accordingly, it is a first objective of the invention to provide for the security of data recorded on a computer readable medium by preventing the data from being read on a computer system other than the computer system in which the data is written.

It is another objective of the invention to provide for the security of such data through the application of cryptographic processes to a data structure much smaller than the data being made secure.

It is another objective of the invention to provide for the security of such data through the application of cryptographic processes within an environment preventing access to such processes through a program surreptitiously executing within the computing system.

It is another objective of the invention to provide for the security of such data through encryption operations occurring before the computer system is shut down, and through decryption operations occurring during the process of system initialization following turning on power to the system, so that the speed of processing during the execution of applications is not effected.

It is another objective of the invention to provide for the security of such data through the use of a process occurring without intervention by the system user.

It is another objective of the invention to provide an interface through which the user can configure the computing system to provide for the security of such data or to operate without providing for the security of such data.

According to a first aspect of the invention, a method is provided for achieving security of a plurality of data records stored on a computer-readable medium within a computing system. The computer readable medium additionally stores a first data structure, starting at a first location within the computer readable medium, locating data records in the plurality thereof. The method comprises an encryption subroutine executed as the computing system is being shut down and a decryption subroutine executed as the computing system is being initialized. The encryption subroutine includes receiving a request to shut down the computing system, reading the first data structure from the computer readable medium, encrypting the first data structure to produce an encrypted version of the first data structure, deleting the first data structure from the computer readable medium, and storing the encrypted version of the first data structure in nonvolatile storage, starting at a second location within the nonvolatile storage. The decryption subroutine includes determining that electrical power has been turned on in the computing system, reading the encrypted version of the first data structure from the nonvolatile storage, decrypting the encrypted version of the first data structure to form the first data structure, and writing the data structure to the computer readable medium, starting at the first location.

According to a second aspect of the invention, a computer system is provided for achieving secure storage of a plurality of data records. The computer system includes a first computer readable medium, a first drive unit, nonvolatile storage, a cryptographic processor, secure storage, and a microprocessor separate from the cryptographic processor. The first computer readable medium the plurality of data records and a first data structure providing locations and sequences for accessing data within the data records. The first drive unit records data on the first computer readable medium and reads data from the computer readable medium. The cryptographic processor is programmed to execute an internal encryption routine to encrypt a data structure, forming an encrypted version of the data structure using an encryption key, and to execute subsequently an internal decryption routine, decrypting the encrypted version of the data structure, using a decryption key. The secure storage, which is accessed by the cryptographic processor, holds data used within the cryptographic processor to derive the decryption key. The microprocessor is programmed to execute a data structure encryption routine to encrypt the first data structure and to execute subsequently a data structure decryption routine to decrypt an encrypted version of the first data structure. The data structure encryption routine includes causing the cryptographic processor to read the first data structure from the computer readable medium, to execute the internal encryption routine, encrypting the data structure to form the encrypted version of the first data structure, and to write the encrypted version of the first data structure to nonvolatile storage. The first data structure is additionally deleted from the first computer readable medium during execution of the data structure encryption subroutine. The data structure decryption subroutine includes causing the cryptographic processor to read the encrypted version of the first data structure from nonvolatile storage, to decrypt the encrypted version of the first data structure, forming the first data structure, and to write the first data structure to the computer readable medium, starting at the first location.

Preferably, the computer readable medium additionally stores a second data structure, starting at a second location within the computer readable medium, describing characteristics of the first data structure, and the data structure encryption subroutine additionally includes reading the second data structure to determine characteristics of the first data structure.

In a first version of the invention, the first drive unit is a hard drive. The data structure encryption subroutine is executed in response to receiving a request to shut down the computer system, and the data structure decryption subroutine is executed in response to electrical power being turned on within the computing system. Preferably, the microprocessor is additionally programmed to execute a configuration subroutine providing a user interface for setting and resetting a configuration bit, and the encryption subroutine is executed according to a state of the configuration bit. Preferably, the encryption subroutine additionally includes setting a flag bit in non-volatile storage, and the decryption subroutine is executed only when the flag bit is set.

In a second version of the invention, the computer readable medium is removable. The method additionally comprises a cryptographic selection subroutine providing a graphical user interface, with the cryptographic selection subroutine including the display of a choice between encryption and decryption, the display of representations of computer readable media in the computer system. After receiving a cryptographic selection signal indicative of whether encryption or decryption is to occur and of a chosen computer readable medium, the system executes the encryption subroutine, with the first data structure of the chosen computer readable medium being encrypted, and the decryption subroutine is executed in response to receiving a cryptographic selection signal indicating decryption is to occur, and with the encrypted version of the first data structure of the chosen computer readable medium being decrypted. Preferably, the encrypted version of the first data structure is stored in nonvolatile storage on the chosen computer readable medium.

### BRIEF DESCRIPTION OF THE FIGURES

FIG. 1 is a pictographic view of formatting at a beginning portion of a conventional hard drive disk having a 12-bit or 16-bit FAT;

FIG. 2 is a pictographic view of formatting at a beginning portion of a conventional hard drive disk having a 32-bit FAT;

FIG. 3 is a pictographic view of formatting at a beginning portion of a conventional hard drive disk formatted according to the NTFS;

FIG. 4 is a block diagram of a computing system in which the present invention is practiced;

FIG. 5 is a flow chart of processes occurring following a power-on in the computing system of FIG. 1, operating in accordance with the present invention;

FIG. 6 is a flow chart of processes occurring during the process of shutting down the computing system of FIG. 1, operating in accordance with the present invention; and

FIG. 7 is a flow chart of processes occurring within the computing system of FIG. 4, operating in accordance with an alternative embodiment of the present invention.

### DETAILED DESCRIPTION OF THE INVENTION

FIG. 4 is a block diagram of a computing system 40 in which the present invention is practiced, showing major structural components of the computing system. The computing system 40 includes a microprocessor 42, which is connected to a system bus 44. Other components connected to the system bus 44 include a read-only memory (ROM) 46 and a random access memory (RAM) 48. An electrically erasable programmable read-only memory (EEPROM) may be used in place of a read-only memory. The microprocessor reads information within both the ROM 46 and the RAM 48, executing program instructions stored within these memory devices, reading data from these devices 46, 48, and recording data in the RAM 48. The ROM 46 stores a basic input output system (BIOS), which is used to initialize various functions within the system 40. While the data stored in a read-only memory cannot be changed, it is seldom necessary to change the BIOS program. Even when such a change is made possible through the use of an EEPROM, it is seldom made.

Various other devices are connected to a peripheral component interconnect (PCI) bus 50 within the computing system 40. The PCI bus 50 is connected to the system bus 44 through a PCI host bridge 52. Devices connected to the PCI bus 50 include a disk adapter 52, which is used to transfer information in either direction between the PCI bus 50 and either a hard drive 54 having disk media 55, which typically include a number of disks, or a diskette drive 56, which accepts a removable diskette medium 57. An audio adapter 58, driving one or more system speakers 60, a graphics adapter 62, driving a display device 64, and a network interface adapter 66, providing a connection to a local area network (LAN) 68. A compact disk (CD RW) drive 70, having a capability to write data on a compact disk medium 72, as well as a capability of reading data from the medium 72, is a universal serial bus (USB) device, connected to the PCI bus 50 through a USB bridge 74. The computing system 40 also includes an industry standard architecture (ISA) bus 76, which is connected to the PCI bus 50 through an expansion bus bridge 78. A keyboard 80 and a mouse 82, or other pointing device, are connected to the ISA bus 76.

The microprocessor 42 also accesses data stored in a battery-backed complementary metal oxide semiconductor (CMOS) memory 77 through the ISA bus 76. The CMOS memory 77 is particularly used to store configuration data describing various components within the system 40. Since such data must remain available when electrical power to the system 40 has been turned off and back on, such data cannot be stored within the RAM 48, which loses data when electrical power is turned off. Yet, as the configuration of the computing system 40 is updated or otherwise changed, the configuration data stored in the CMOS memory 77 must be changed by methods provided during execution of the BIOS program.

According to a preferred version of the present invention, this data includes a flag bit, which is used to determine whether the selective encryption feature of the present invention will be used to provide file security.

Furthermore, the computing system 40 includes a security chip 84, which is of particular importance in implementing a preferred version of the present invention. The security chip 84 includes a cryptographic processor 86 and secure storage 88. The secure storage 88 is particularly used to store cryptographic keys, which are used in cryptographic operations carried out within the cryptographic processor 86. In particular, cryptographic operations may include the application of the RSA encryption algorithm, using a private key and a public key. At least the private key is stored only within the secure storage 88, so that it is not accessible to other programs executing within the computing system. A substantial level of security is achieved in this way, since the private key cannot be accessed surreptitiously, as by a Trojan horse program. Since the private key must not be transmitted outside the security chip 84, all of the operations involving its use must take place within the cryptographic processor 86 of the security chip 84. The cryptographic processor 86 is connected to the PCI host bridge 52 through the system management bus (SMB) 90, which is a serial bus operating at less that 1 MHz. While the capabilities of this bus are sufficient for the intended application, its data transfer rate discourages the encryption of large quantities of data within the cryptographic processor 86.

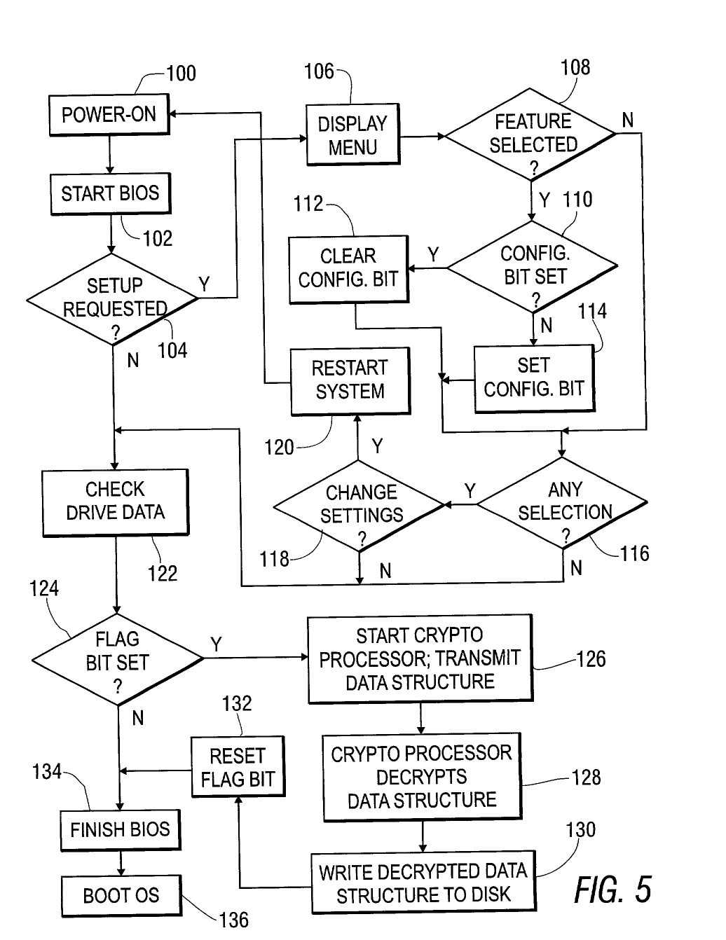

FIG. 5 is a flow chart of process occurring after the electrical power is turned on within the computing system 40 in step 100. Then, in step 102, microprocessor 42 first begins execution of instructions within the BIOS routine, stored in ROM 46, to perform a number of operations initializing the operation of the system 40. For example, the BIOS system performs a number of component tests that are included in a power-on self test (POST) subroutine.

In accordance with a preferred version of the present invention, a setup process is provided, allowing the system user to configure the computing system 40 to provide for the security of data recorded on disk medium 55 within the hard drive 54 through choosing a selective encryption process, or to operate without providing for such data security by deselecting the selective encryption process. For example, the system is configured to provide for such data security by setting a configuration bit within the CMOS memory 77 and to operate without providing for such data security by resetting this configuration bit. Since a conventional BIOS program executing within a computing system provides a user interface for a setup process for configuring a number of devices within the computing system, this setup process is extended to include setting and resetting the configuration bit used to control the selective encryption processes of the present invention. This setup process is entered when the system user pushes a predetermined key on the keyboard 80, or a predetermined combination of such keys, in step 104, within a time frame provided during execution of the BIOS program. Thus, when a determination is made that the setup process has been selected in step 104, a setup menu is displayed on the display 64 in step 106. This menu includes a choice to change the status of the selective encryption feature of the present invention. If this feature is selected, as determined in step 108, a determination is made in step 110 of whether the configuration bit is set. If the configuration bit is determined to be set, it is cleared in step 112; if it is determined not to be set, it is set in step 114. Alternately, bits subsequently used to set or clear the actual configuration bit in CMOS memory 77 may be set or cleared in steps 112, 114. In any case, in the example of FIG. 5, a selection process is established to toggle the value of the configuration bit, with the configuration bit being set to establish subsequent operation of the selective encryption process and reset to end the operation of the selective encryption process. Another menu format, such a choice to make the selective encryption process active or inactive, may alternately be given.

The selection process begun in step 104 can be used to set of number of parameters of devices within the computing system 40. Therefore, if the process for setting or clearing the configuration bit has not been chosen, as indicated in step 108, or if the configuration bit has been set in step 114 or reset in step 112. When the user determines to exit the configuration process, the system proceeds to step 116, in which a further determination is made of whether the user has selected to make any setup change, including the choice to change the configuration bit. If he has selected such a change, or a number of such changes, he is given a choice in step 118 of whether he wants to make the selected changes to the setup configuration. If he makes a menu selection indicating that the changes should be made, the computing system 40 is turned off and restarted in step 120, with the changes taking place as the system is again initialized after returning to step 100. On the other hand, if the decision to execute the setup process is not made, as determined in step 104, if no selection of a parameter to be changed has been made when the user decides to exit the configuration process, as determined in step 116, or if the user decides not to cause the changes he has selected to be reflected in changes to the CMOS memory 77, as determined in step 118, the system proceeds to step 122 without restarting in step 120.

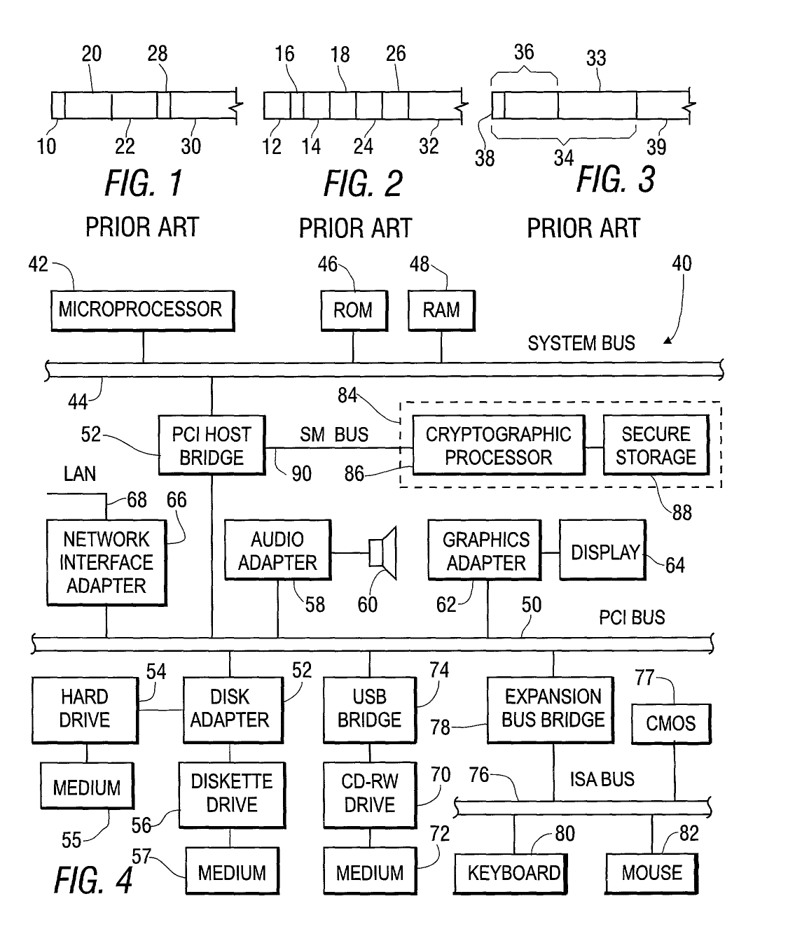

Also in accordance with a preferred version of the present invention, a first data structure recorded on the medium 55 is selectively encrypted, with the first data structure including information locating various data records on the medium 55, and with a second data structure, describing characteristics of the first data structure, is never encrypted. Therefore, whether the first data structure is encrypted or not, the second data structure, which is not encrypted, is checked in step 122 to determine the type of file system used. For example, referring to FIG. 1, the first data structure may be a pair of 12-bit or 16-bit FAT tables 20, 22, while the second data structure is the boot record 10. Alternately, referring to FIG. 2, the first data structure may be a pair of 32-bit FAT tables 24, 26, while the second data structure is the boot record 12. Alternately, referring to FIG. 3, the first data structure may be an array of file records within the master file table 34, while the second data structure is the metadata files 36 or the first file 38 within the master file table 34.

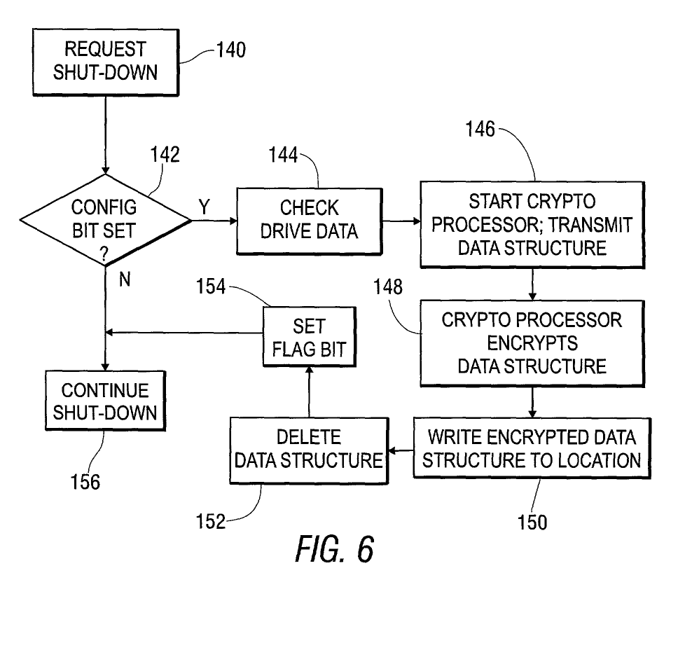

Further in accordance with a preferred version of the present invention, in a manner to be described in reference to FIG. 6, a flag bit is set in nonvolatile storage whenever the first data structure of the hard drive medium 55 is encrypted. Then, during the BIOS initialization program, in step 124, this flag bit is checked. If it has been set, it is known that the first data structure has been encrypted, so, in step 126, the microprocessor 42 reads an encrypted version of the first data structure from nonvolatile storage, in which it has been previously written, starts the cryptographic processor 86, and transfers the encrypted version of the first data structure to the cryptographic processor 86, and also reads a. Then, in step 128, the cryptographic processor decrypts the first data structure, using a decryption key, or data used to develop a decryption key, read from secure storage 88. In step 130, the decrypted data structure is written to the hard file disk medium 55. This action effectively restores the first data structure to its condition before encryption, so that it can be used by an operating system in a conventional manner to locate files. Since the first data structure has been restored in this way, the flag bit is reset in step 132. Then, any remaining portions of the BIOS initialization program are completed in step 134, and the operating system is booted in step 136. On the other hand, if the flag bit is determined in step 124 not to be set, it is known that the first data structure has not been encrypted, so the system from step 124 to step 134, with the first data structure already being in a form that can be used by the operating system in a conventional manner to locate files.

FIG. 6 is a flow chart of processes occurring as the computing system 40 is being shut down. In addition to encrypting the first data structure when the system 40 is configured to do so, a number of conventional actions are taken. For example, files opened using application programs and temporarily stored in RAM 48 are examined to determine whether they have been modified since they were opened. If such files have been modified, the user is asked, through menu items presented on the display unit 64, if he wants to save the modified files before the system shuts down. Other files have to be closed before the system is shut down, according to rules implemented in the operating system.

The processes of FIG. 6 begin when the user requests a shut-down of the computing system 40 in step 140. Next, in step 142, a determination is made of whether the configuration bit has been set in the CMOS memory 77. If this bit has been set, the encryption process begins with the second data structure, being checked in step 144 to determine the type of file system used. Then, in step 146, the microprocessor 42 reads the first data structure from the hard drive disk 55, starts the cryptographic processor 86 and transmits this first data structure to the cryptographic processor 86. Then, in step 148, the cryptographic processor 86 encrypts the first data structure, using an encryption key or data used to generate an encryption key read from secure storage 88. Next, in step 150, the cryptographic processor writes the encrypted version of the first data structure to a location in nonvolatile storage. In step 152, the first data structure is deleted from its location on the hard drive disk 55. Then, in step 154, the flag bit is set in set in nonvolatile storage, so that the system will know that the first data structure has been encrypted when it is next turned on. The system then proceeds to step 156, in which the shut down process is continued. On the other hand, if a determination is made in step 142 that the configuration bit has not been set in the CMOS memory, it is known that the computing system 40 has not been configured to perform this encryption, so the system proceeds directly from step 142 to step 156.

In the FAT-based file systems of FIGS. 1 and 2, first data structure typically includes two copies of the FAT table. The second of these copies is used by the operating system in the event that the first of these copies becomes corrupted. Therefore, while both copies of the FAT table must be encrypted to provide data security, if the encryption algorithm would otherwise cause data from one of these copies to become mixed with data from the other of these copies, these two copies are preferably encrypted and subsequently decrypted separately.

In some instances, the first data structure of a computer readable medium 55 is recorded in contiguous segments of the medium 55. In other instances the first contiguous segments in which the first data structure is recorded include a number of pointers to other segments in which other portions of the medium 55. In one version of the present invention, the cryptographic processor follows these pointers to encrypt data from other areas; in another version the pointers themselves are encrypted, while the data to which they point is left alone, since it cannot readily be found without access to the pointers.

In some instances, the file structure of the computer readable medium 55 is divided among a number of logical devices, each of which has a separate portion of the first data structure. Preferably, each of these portions are separately encrypted and decrypted.

In step 150 of FIG. 6, the microprocessor 42 writes encrypted version of the first data structure produced by the cryptographic processor 86 to a location in nonvolatile storage, so that it will be available after the computing system 40 is shut down and again powered on, to be available to be read in step 126 of FIG. 5. In this context, nonvolatile storage is understood to mean storage, which can be written to, or read from, and which retains the data it holds when the power to the computing system 40 is turned of and later turned on. Thus, if a nonvolatile memory device, such as a FLASH memory, is available within the computing system 40, the encrypted version of the first data structure may be written to such memory. Alternately, this encrypted version may be written to a predetermined location on the hard drive medium 55. Some processes for encryption and decryption do not substantially vary the length of the data being encrypted and decrypted. Such processes include the substitution of values and adding a number, which may be generated by multiplying a pair of prime numbers, equal in length to the data being encrypted, with or without carrying within the addition process, and subsequently subtracting the number in a similar manner. If such a process is used, the encrypted version of the first data structure can be stored in nonvolatile storage in the space on the hard drive medium 55 formerly used for the first data structure itself.

In step 152 of FIG. 6, the unencrypted version of the first data structure is deleted from the hard file medium 57. Such deletion may be performed by modifying the first data structure so that it appears to a conventional operating system as having been deleted. If the encrypted version of the first data structure is written in the same space as the unencrypted version, writing the encrypted version will accomplish this process of deletion.

The cryptographic processor 86 may use the RSA algorithm, which is well known to those skilled in the art of cryptography, with a private key held within secure storage 88 being used for decryption, and with a public key, held in nonvolatile storage, but not necessarily in secure storage, being used for encryption. The cryptographic processor 86 may be used for a number of other cryptographic purposes, which, together with the private key, are not made available to the processor 40, in which a program may be surreptitiously operating.

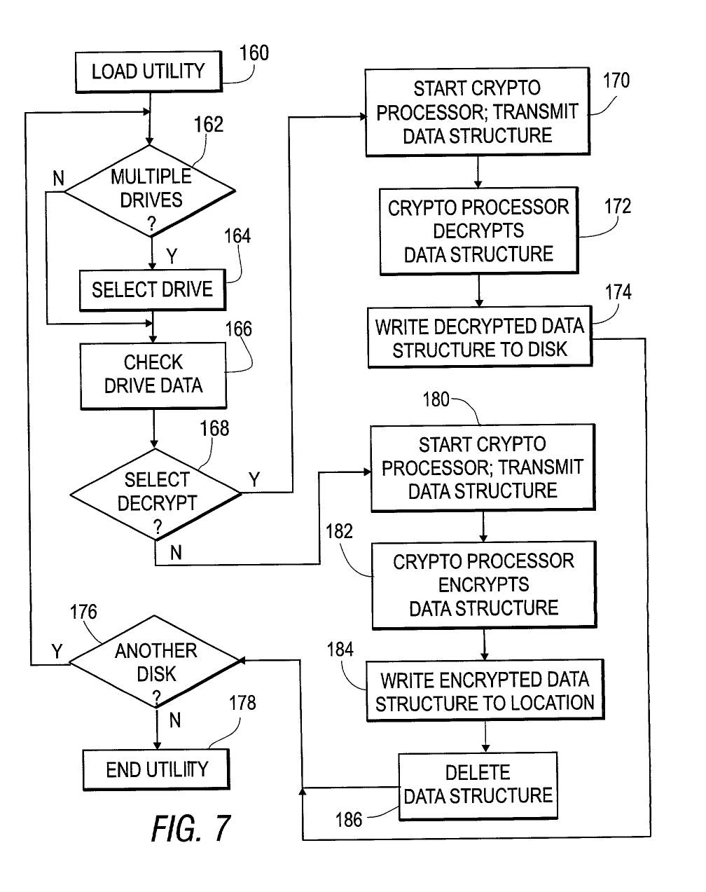

FIG. 7 is a flow chart of processes occurring within the computing system 40 in accordance with an alternative embodiment of the present invention, providing for the security of data records recorded on a removable medium, such as a floppy diskette 57 in diskette drive 56.

A first significant difference between such a removable medium 57 and the hard drive medium 55 arises from the fact that the removable medium 57 can be installed in, or removed from, its associated drive unit 56 at any time during the operation of the computing system 40, while the hard drive medium 55 must remain within the hard drive 54 during operation of the computing system 40. Thus, it is not reasonable to expect that the removable medium 57 will be in place for decryption when the computing system 40 is initialized, or that it will still be in place for encryption as the computing system 40 is shut down. Thus, a utility program is provided to allow the encryption of a first data structure on the removable medium or the subsequent decryption of an encrypted version of the first data structure at any time after the utility program is loaded in step 160.

A second significant difference between the removable medium 57 and the hard drive medium 55 arises from the fact that most of the uses to which the removable medium 57 is put involve recording data in one computing system to be read in another computing system. In such applications, it is unreasonable to encrypt the first data structure of the removable medium 57 so that the data records recorded on the removable medium 57 can only be read on the system in which they were recorded. However, one important application for removable media is the archival storage of information, including back-up information stored so that it will be available in the event of the failure of the computing system 40. While removable media 57 used for such archival storage may normally be read from or recorded upon within a single computing system 40, at least a possibility of reading the media 57 in another computing system 40 should be retained, so that data will not be lost in the event of a failure of the computing system 40. Therefore, a copy of the decryption key, or at least a copy of data sufficient to generate the decryption key should be retained by the system user or by another individual, such as a security administrator having responsibility for a number of computing systems 40 within an organization.

After the utility program is loaded in step 160, a determination is made in step 162 of whether the computing system 40 has more than one drive using removable media. In general, the computing system 40 may have several drives using removable media, any of which may include files to be protected by the means of the method of the present invention. If the computing system 40 has multiple drives, a dialog box is displayed on the display unit 64, providing the user with the ability to select the drive by making a menu choice in step 164. Then the system proceeds to step 166 to determine the characteristics of the first data structure on the removable medium 57 by reading the second data structure on the removable medium 57. If the computing system 40 includes only one drive using a removable medium, the system proceeds directly from step 162 to step 166.

In the example of FIG. 4, the removable medium 57 is a floppy diskette, which presumably has data recorded in a 12-bit FAT format, like all standard diskettes, as shown in FIG. 1. Thus, the boot record 10 is stored in the first sector of the disk, forming the second data structure, while first and second copies 20, 22 of the FAT follow the boot record 10, together forming the first data structure.

Referring again to FIG. 7, after the characteristics of the first data structure are determined in step 166, the system proceeds to step 168, in which the user is presented with another dialog box on the screen of the display 64, allowing him to determine whether a decryption or encryption process is to be performed. If he selects to decrypt, the system proceeds to step 170, in which the microprocessor 42 reads an encrypted version of the first data structure from the removable medium 57, starts the cryptographic processor 86, and transmits this encrypted version of the first data structure to the cryptographic processor 86. Next, in step 172, the cryptographic processor 86 decrypts the encrypted version first data structure, using a decryption code, or data used to generate the decryption code, from secure storage 88. Then, in step 174, the first data structure, now decrypted, is written to the removable medium 57.

Since the user may want to perform decryption or encryption operations on more than one removable medium, the system proceeds from step 174 to step 176, in which a dialog box is presented on the screen of display, allowing the user to indicate whether he wants to perform such an operation on another disk. If he does, the system returns to step 162; if he does not, the utility is ended in step 178.

On the other hand, if the user decides in step 168 to encrypt a first data structure of the removable medium 57, the system proceeds to step 180, in which the microprocessor 42 reads the first data structure from the removable medium 57, starts the cryptographic processor 86, and transfers this data structure to the cryptographic processor 86. Then, in step 182, the cryptographic processor 86 encrypts the data structure, using an encryption key read from nonvolatile storage. If the cryptographic algorithm being applied within the processor 86 is asymmetric, using a decryption key that cannot be reasonably determined from the encryption key, it is not necessary to store the encryption key in secure storage 88. Next, in step 182, the cryptographic processor 86 encrypts the first data structure. In step 184, the microprocessor 42 writes the encrypted version of the first data structure to a location on the removable medium 57. In step 186, the unencrypted version of the first data structure is deleted from the removable medium 57. Other aspects of the encryption and decryption processes are generally as described above in reference to FIGS. 5 and 6.

While the present invention has been described with encryption and decryption occurring within a cryptographic processor 86, it is understood that the present invention may otherwise be carried out with these steps occurring in the microprocessor 42, using an encryption routine executing within the microprocessor 42.

While the present invention has been described in its preferred versions or embodiments with some degree of particularity, it is understood that this description has been given only by way of example, and that various changes in the arrangement of parts and process steps can be made without varying from the spirit and scope of the invention.

We claim:

1. A method providing security for a plurality of data records stored on a computer-readable medium within a computing system, wherein
said computer readable medium additionally stores a first data structure, starting at a first location within said computer readable medium, locating data records in said plurality thereof,
said method comprises an encryption subroutine executed as said computing system is being shut down and a decryption subroutine executed as said computing system is being initialized,
said encryption subroutine includes receiving a request to shut down said computing system, reading said first data structure from said computer readable medium, encrypting said first data structure to produce an encrypted version of said first data structure, deleting said first data structure from said computer readable medium, and storing said encrypted version of said first data structure in nonvolatile storage, starting at a second location within said nonvolatile storage, and
said decryption subroutine includes determining that electrical power has been turned on in said computing system, reading said encrypted version of said first data structure from said nonvolatile storage, decrypting said encrypted version of said first data structure to form said first data structure, and writing said data structure to said computer readable medium, starting at said first location.

2. The method of claim 1, wherein said second location is on said computer readable medium

3. The method of claim 2, wherein said second location is at said first location.

4. The method of claim 1, wherein said nonvolatile storage is a memory structure, separate from said computer readable medium, within said computing system.

5. The method of claim 1, wherein
encryption of said first data structure occurs within a cryptographic processor in said computing system using an encryption key,
said cryptographic processor is separate from a system processor within said computing system, and
decryption of said encrypted version of said first data structure occurs within said cryptographic processor in said computing system using a decryption key generated from data stored in secure storage accessed by said cryptographic processor.

6. The method of claim 1, wherein
a public key of said computing system is used for encryption of said first data structure, and
a private key of said computing system is used for decryption of said encrypted version of said first data structure.

7. The method of claim 1, wherein said encrypted version of said first data structure is equal in length to said first data structure.

8. The method of claim 1, wherein
said computer readable medium additionally stores a second data structure, starting at a second location within said computer readable medium, describing characteristics of said first data structure, and
said encryption subroutine additionally includes reading said second data structure to determine characteristics of said first data structure.

9. The method of claim 8, wherein
said first data structure is a file allocation table, and
said second data structure is a boot record.

10. The method of claim 8, wherein
said first data structure includes an array of file records in a master file table of a NTFS file, and
said second data structure includes metafile data in said master file table.

11. The method of claim 1, wherein
said method additionally comprises a configuration subroutine providing a user interface for setting and resetting a configuration bit, and
said encryption subroutine is executed according to a state of said configuration bit.

12. The method of claim 11, wherein
said encryption subroutine additionally includes setting a flag bit in nonvolatile storage, and
said decryption subroutine is executed only when said flag bit is set.

13. A method providing security for a plurality of data records stored on a computer readable medium within a computing system, wherein
said computer medium additionally stores a first data structure starting at a first location within said removable computer readable medium, locating data records in said plurality thereof,
said method comprises an encryption subroutine executed to encrypt said first data structure and a decryption subroutine subsequently executed to decrypt an encrypted version of said first data structure,
said encryption subroutine includes reading said first data structure from said computer readable medium, encrypting said first data structure within a cryptographic processor in said computing system using an encryption key to produce an encrypted version of said first data structure, deleting said first data structure from said computer readable medium, and storing said encrypted version of said first data structure in nonvolatile storage, starting at a second location within said nonvolatile storage, and
said decryption subroutine includes reading said encrypted version of said first data structure from said nonvolatile storage, decrypting said encrypted version of said first data structure within said cryptographic processor in said computing system using a decryption key generated from data stored in secure storage accessed by said cryptographic processor to form said first data structure, and writing said data structure to said computer readable medium, starting at said first location.

14. The method of claim 13, wherein
said encryption subroutine is executed in response to receiving a request to shut down said computing system, and
said decryption subroutine is executed in response to electrical power being turned on within said computing system.

15. The method of claim 14, wherein
said method additionally comprises a configuration subroutine providing a user interface for setting and resetting a configuration bit, and
said encryption subroutine is executed according to a state of said configuration bit.

16. The method of claim 15, wherein
said encryption subroutine additionally includes setting a flag bit in nonvolatile storage, and
said decryption subroutine is executed only when said flag bit is set.

17. The method of claim 13, wherein
said method additionally comprises a cryptographic selection subroutine providing a graphical user interface,
said cryptographic selection subroutine includes displaying a choice between encryption and decryption, displaying representations of computer readable medium in said computing system, and receiving a cryptographic selection signal indicative of whether encryption or decryption is to occur and of a chosen computer readable medium,
said encryption subroutine is executed in response to receiving a cryptographic selection signal indicating encryption is to occur, with said first data structure of said chosen computer readable medium being encrypted, and
said decryption subroutine is executed in response to receiving a cryptographic selection signal indicating decryption is to occur, and with said encrypted version of said first data structure of said chosen computer readable medium being decrypted.

18. The method of claim 17, wherein said encrypted version of said first data structure is stored in nonvolatile storage on said chosen computer readable medium.

19. A computing system providing secure storage of a plurality of data records comprising:
a first computer readable medium storing said plurality of data records and a first data structure providing locations and sequences for accessing data within said data records;
a first drive unit recording data on said first computer readable medium and reading data from said computer readable medium;
nonvolatile storage;
a cryptographic processor, wherein said cryptographic processor is programmed to execute an internal encryption routine to encrypt a data structure, forming an encrypted version of said data structure using an encryption key, and to execute subsequently an internal decryption routine, decrypting said encrypted version of said data structure, using a decryption key;
secure storage accessed by said cryptographic processor, holding data used within said cryptographic processor to derive said decryption key;
a microprocessor, separate from said cryptographic processor, wherein said microprocessor is programmed to execute a data structure encryption routine to encrypt said first data structure and to execute subsequently a data structure decryption routine to decrypt an encrypted version of said first data structure, wherein said data structure encryption routine includes causing said cryptographic processor to read said first data structure from said computer readable medium, to execute said internal encryption routine, encrypting said data structure to form said encrypted version of said first data structure, and to write said encrypted version of said first data structure to nonvolatile storage, wherein said first data structure is additionally deleted from said first computer readable medium during execution of said data structure encryption subroutine, and wherein said data structure decryption subroutine includes causing said cryptographic processor to read said encrypted version of said first data structure from nonvolatile storage, to decrypt said encrypted version of said first data structure, forming said first data structure, and to write said first data structure to said computer readable medium, starting at said first location.

20. The computing system of claim 19, wherein
said first drive unit is a hard drive,
said data structure encryption subroutine is executed in response to receiving a request to shut down said computing system, and
said data structure decryption subroutine is executed in response to electrical power being turned on within said computing system.

21. The computing system of claim 20, wherein
said microprocessor is additionally programmed to execute a configuration subroutine providing a user interface for setting and resetting a configuration bit, and
said encryption subroutine is executed according to a state of said configuration bit.

22. The computing system of claim 21, wherein
said encryption subroutine additionally includes setting a flag bit in nonvolatile storage, and
said decryption subroutine is executed only when said flag bit is set.

23. The computing system of claim 19, wherein
said computer readable medium is removable,
said method additionally comprises a cryptographic selection subroutine providing a graphical user interface,
said cryptographic selection subroutine includes displaying a choice between encryption and decryption, displaying representations of computer readable medium in said computing system, and receiving a cryptographic selection signal indicative of whether encryption or decryption is to occur and of a chosen computer readable medium,
said encryption subroutine is executed in response to receiving a cryptographic selection signal indicating encryption is to occur, with said first data structure of said chosen computer readable medium being encrypted, and
said decryption subroutine is executed in response to receiving a cryptographic selection signal indicating decryption is to occur, and with said encrypted version of said first data structure of said chosen computer readable medium being decrypted.

24. The computing system of claim 23, wherein said encrypted version of said first data structure is stored in nonvolatile storage on said chosen computer readable medium.

25. The computing system of claim 19, wherein
said computer readable medium additionally stores a second data structure, starting at a second location within said computer readable medium, describing characteristics of said first data structure, and
said data structure encryption subroutine additionally includes reading said second data structure to determine characteristics of said first data structure.
